(19) United States
(12) Patent Application Publication
(10) Pub. No.: US 2004/0106410 A1
(43) Pub. Date: Jun. 3, 2004

(54) Apparatus and method for estimating cell coverage using interference model

(76) Inventors: Yong-Seouk Choi, Daejeon (KR); Nam-Hoon Park, Daejeon (KR); Dae-Sik Kim, Daejeon (KR); Nam Kim, Cheongju (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/334,940

(22) Filed: Dec. 31, 2002

(30) Foreign Application Priority Data
Dec. 2, 2002 (KR) 2002-75923

(51) Int. Cl. H04Q 7/20

(52) U.S. Cl. 455/446; 455/403

(57) ABSTRACT

An apparatus and method for estimating a cell coverage includes: a terrain data processor for dividing an area for calculation of the coverage into pixels of a size; a traffic calculator for estimating a traffic volume by the pixels; a forward coverage estimator for calculating path loss information according to the pixel-based traffic volume and a traffic carrying capacity of the base station and determining a forward link capacity and a forward coverage; and a backward coverage estimator for calculating a same-cell interference and an adjacent-cell interference using the path loss information between the base stations and determining a backward link capacity and a backward coverage, thus determining a cell coverage approximating the actual coverage by including a same-cell interference and an adjacent-cell interference.

### BACKGROUND OF THE INVENTION

(a) Field of the Invention

The present invention relates to mobile communication. More particularly, the present invention relates to an apparatus and method for estimating a cell coverage using an interference model.

(b) Description of the Related Art

In recent years, with an explosive increase in the number of subscribers to mobile communication systems and development of mobile communication technologies, there has been an increasing demand for a variety of services. Effective cell design and optimization is of great importance for the next generation mobile communication systems. For this purpose, a dynamic cell design based on the traffic carrying capacity of a base station and interference is more necessary than the passive method of determining a service area of the base station, i.e., cell coverage according to propagation loss.

In designing a cell of the base station, the process of optimizing the position and the number of base stations is very significant in the aspect of cost and use of propagation. The basis of the optimization process is the cell coverage occupied by the individual base stations.

Conventionally, the estimation of a cell coverage is primarily based on the distance according to propagation loss with respect to the output of the base station, and the position of the base station has been determined based on the experience of the operators. In this case, the optimization for covering a maximum area with a minimum number of base stations is difficult to realize.

Although audio communication is now relatively important, data transmission will be more important in the future mobile communication network, resulting in a demand for hot-spot cells for providing high-speed data communication.

To meet the demand for various services according to the increased number of subscribers to data services, it is necessary to formulate an effective cell design plan before or after system operation.

The purpose of cell design is to realize a maximum capacity with a minimum number of base stations. In the aspect of cell coverage, a propagation model for the propagation environment extending from pico-cell and micro-cell to macro-cell that allows modeling of the hierarchical cell environment is required. Also, the arrangement of base stations based on the traffic distribution of users in the cell must be taken into consideration.

As the cells assume a complicated aspect, there are more overlaps of the cells, and a modeling process for interference between cells is needed due to characterized cells.

Now, a description will be given as to the prior art for cell design.

The prior art is disclosed in Korean Patent Laid-open No. 1999-35739 (applicant: KT Corporation).

This prior art relates to a cell coverage estimation method for a wireless network design system. To enhance the calculation speed of the propagation interpreting function realized in the wireless design system, the method includes calculating a received signal power only for a minimum number of bins necessary for calculation of the cell coverage using a search technology such as the binary search technology to approximately estimate a cell coverage, instead of using a LOS (Line of Sight) or calculating a received signal power for all bins corresponding to the respective radials.

More specifically, the conventional cell coverage estimation method includes: (a) reading out terrain information to search LOS paths for all radials, (b) connecting all LOS points to define a service area, and (c) outputting the determined service area, thereby estimating a service range in a shorter time than in the case of positioning the base station.

However, the conventional method approximately estimates a cell coverage through calculation of the path-based received signal at a target area, and thereby it has difficulty in determining the cell coverage with accuracy.

### SUMMARY OF THE INVENTION

It is an object of the present invention to solve the problems with the prior art and to provide an apparatus and method for estimating a cell coverage using an interference model that allows estimation of a cell coverage approximating an actual cell coverage with an interference model inevitably occurring in a code division multiple access (CDMA) system in consideration of the effects of interferences in designing a cell.

In one aspect of the present invention, there is provided an apparatus for estimating a cell coverage using an interference model that includes: a terrain data processor for dividing an area for calculation of the coverage into pixels of a predetermined size; a traffic calculator for estimating a traffic volume by the respective pixels; a forward coverage estimator for calculating path loss information according to the pixel-based traffic volume and a predetermined traffic carrying capacity of the base station and determining a forward link capacity and a forward coverage; and a backward coverage estimator for calculating a same-cell interference and an adjacent-cell interference using the path loss information between the base stations and determining a backward link capacity and a backward coverage, thus determining a cell coverage approximating the actual coverage by including a same-cell interference and an adjacent-cell interference inevitably occurring in the backward link after estimation of a forward link coverage based on the traffic volume.

In another aspect of the present invention, there is provided a method for estimating a cell coverage using an interference model that includes:

(a) dividing an area for calculation of the coverage into pixels of a predetermined size; (b) calculating a traffic volume by the respective pixels; (c) calculating path loss information according to the pixel-based traffic volume and a predetermined traffic carrying capacity of the base station to determine a forward link capacity and a forward coverage; and (d) calculating a same-cell interference and an adjacent-cell interference using the path loss information between the base stations to determine a backward link capacity and a backward coverage.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic of an apparatus for estimating a cell coverage in accordance with an embodiment of the present invention;

FIG. 2 is a flow chart showing a calculation method of a backward link capacity and a backward coverage in a method for estimating a cell coverage in accordance with an embodiment of the present invention; and

FIG. 3 is a flow chart showing a calculation method of a forward link capacity and a forward coverage in a method for estimating a cell coverage in accordance with an embodiment of the present invention.

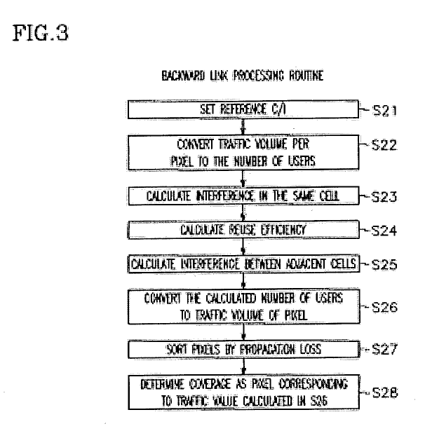

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

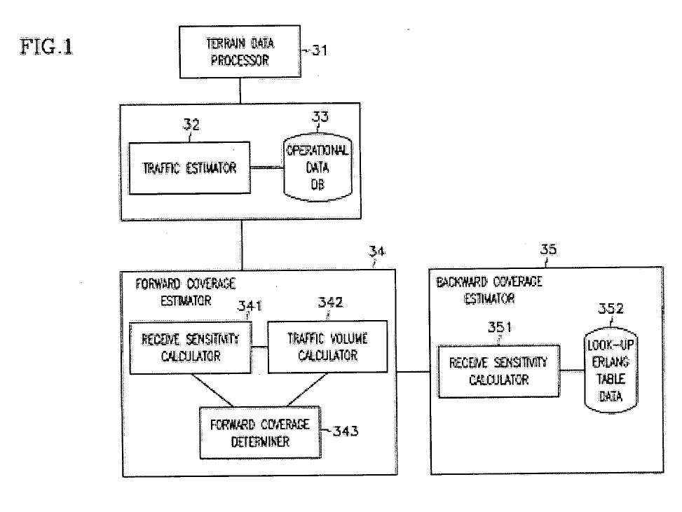

FIG. 1 is a schematic of an apparatus for estimating a cell coverage in accordance with an embodiment of the present invention.

Referring to FIG. 1, the apparatus for estimating a cell coverage according to the embodiment of the present invention comprises a terrain data processor 31, a traffic estimator 32, a forward coverage estimator 34, and a backward coverage estimator 35.

The terrain data processor 31 divides an area for calculation of the coverage into pixels of a predetermined size. The traffic estimator 32 estimates traffic volume by the respective pixels. The forward coverage estimator 34 calculates path loss information according to the pixel-based traffic volume and a predetermined traffic carrying capacity of the base station to determine a forward link capacity and a forward coverage. The backward coverage estimator 35 calculates a same-cell interference and an adjacent-cell interference using the path loss information between the base stations to determine a backward link capacity and a backward coverage.

Now, a description will be given as to an operation of the apparatus for estimating a cell coverage in accordance with the embodiment of the present invention.

First, the terrain data processor 31 divides the areas for calculation of the coverage into pixels of a predetermined size and determines a traffic volume by the respective pixels.

For the pixel-based traffic estimation, the average traffic volume by the respective areas, i.e., downtown, office complex or residential district is calculated using the existing operational data with reference to an operational database 33. In this case, the number of pixels occupying each area is the traffic size. So the traffic estimation can be performed in a simple way.

The embodiment of the present invention uses the respective pixels and a loss of the path from all the necessary base stations.

The capacity and coverage in the forward link are determined by a receive sensitivity calculator 341 using the sensitivity of the base station and the traffic carrying capacity of the base station.

The base station transmit power is initialized to a maximum value and the individual pixel is considered to be linked to the base station having the highest receive sensitivity among the base stations having a receive sensitivity greater than a receiver sensitivity using the stored path loss value.

When the sum of the pixels in the base station coverage, i.e., the total traffic volume exceeds the traffic carrying capacity of the base station, the traffic volume calculator 342 arranges the respective pixels according to the path loss, and adjusts the base station transmit power so as to link the pixels by as much as the traffic carrying capacity of the base station.

In this case, the forward coverage determiner 343 adjusts the transmit power as much as the coverage corresponding to the total capacity of the base station. Accordingly, it is possible to minimize the effect of the interfering transmit power exceeding the capacity on other adjacent cells.

Referring to FIG. 1, the process of determining a forward coverage involves initialization of the base station transmit power to a predetermined value, in step 11.

The subsequent step is a process of determining an active cell.

The sensitivity at the receiver is determined by using a path loss in the individual pixel unit in an area that is divided into pixel units. The receiver of the individual pixel belongs to a base station having the highest received signal power from the individual base stations.

Through this process, the individual pixels in the area belong to a base station having the highest received power, in step 12.

The next process is determining the traffic volume of the active cell determined in the previous process. As the traffic volume per pixel is already known, the total traffic volume in the cell can be readily calculated from the number of pixels, in step 13.

The traffic volume previously calculated is compared with the traffic carrying capacity of the base station, in step 14.

If the traffic volume is not greater than the traffic carrying capacity of the base station, then the coverage is the currently determined active cell, in step 17. Otherwise, if the traffic volume is greater than the traffic carrying capacity of the base station, then the cell area is reduced to as much as the traffic carrying capacity, while excluding the pixels starting with a pixel having the greatest propagation loss, i.e., having the lowest receive sensitivity, in step 15. Then the cell coverage is determined as a coverage corresponding to the traffic carrying capacity, in step 16.

In the backward link, the capacity is limited by an inference with other users, and the total average interference power in the backward link is the sum of a self cell interference and an adjacent cell interference, as expressed by the following equation:

I_{T}=I_{SC}+I_{OC} [Equation 1]

In the case of complete power control for self cell interference, the receive sensitivity at the base station is the same level, and the self cell interference is given by the following equation:

I_{sc}=(M−1)·S·αᵣ [Equation 2]

where M is the number of users linked in the current cell, and αᵣ is the average activity of the users.

The propagation loss between a user defined as a pixel and an effective base station is defined as a function of distance from altitude information and can be expressed by the following equation, in the case of complete power control:

The transmit power of a mobile in an interfering cell=target power level at base station×gain to offset propagation loss=S·L(rᵢ) [Equation 3]

Accordingly, the received power at a reference cell for the transmit power of the i-th user is expressed by the equation 4, and the total average adjacent cell interference power is given by the equation 5:

$$\begin{matrix}{P}_{0} = {α}_{r} \cdot \frac{L ( {r}_{i} )}{L ( {r}_{oi} )} & [ Equation 4 ] \\ {I}_{OC} = {α}_{r} \cdot S \cdot {\sum }_{i} \frac{L ( {r}_{i} )}{L ( {r}_{oi} )} = ξ \cdot M \cdot {α}_{r} \cdot S & [ Equation 5 ]\end{matrix}$$

where ξ is a reuse fraction defined as a ratio of the adjacent-cell interference received power to a same-cell interference received power, as given by the following equation:

ξ=(total other cell received power)/(total same cell received power) =reuse fraction [Equation 6]

From the equations 2 and 5, the total average interfering power can be expressed by the following equation:

[Equation 7]

$${I}_{r} = {I}_{SC} + {I}_{OC} \\ = ( M - 1 ) \cdot {α}_{r} \cdot S + ξ \cdot M \cdot {α}_{r} \cdot S \\ = [ ( 1 + ξ ) \cdot M - 1 ] \cdot {α}_{r} \cdot S \\ = [ \frac{M}{{F}_{e}} - 1 ] \cdot {α}_{r} \cdot S$$

where Fₑ is the reuse efficiency and is defined by the following equation:

[Equation 8]

$${F}_{e} = \frac{1}{1 + ξ}$$

=(total same−cell power)/(total same−plus other−cell power)<1

When the effect of thermal noise is ignored, the required signal-to-noise ratio (SNR) can be calculated according to the following equation 9 by using the total average interfering power defined by the equation 7. The receive sensitivity calculator 351 uses the required SNR to calculate the number of users in the reference cell as expressed by the following equation 10:

$${( \frac{C}{1} )}_{req} = {SNR}_{req} = \frac{{α}_{r} \cdot S}{( \frac{M}{{F}_{e}} - 1 ) \cdot {α}_{r} \cdot S} = \frac{1}{\frac{M}{{F}_{e}} - 1} \qquad [ Equation 9 ]$$

$$M = {F}_{e} \cdot [ \frac{1}{{( C / I )}_{req}} + 1 ] \qquad [ Equation 10 ]$$

The traffic volume and the number of users are applied to make up a loop-up Erlang table 352 based on the existing operational data.

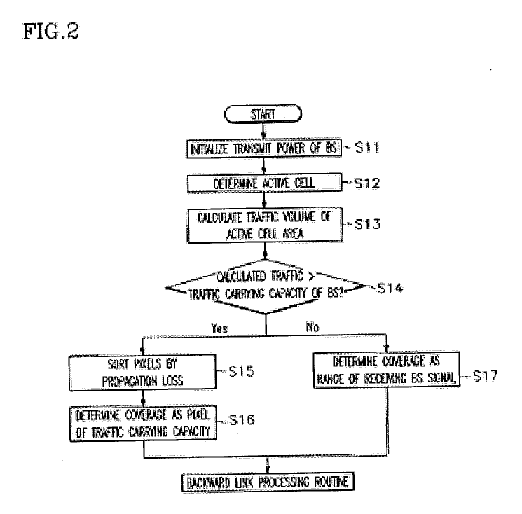

Now, a description will be given as to the method for calculating a backward link coverage as illustrated in FIG. 2.

First, a reference C/I (carrier-to-interference ratio) is determined, in step 21. Then the traffic volume 16 previously determined in the forward link coverage is calculated using the loop-up Erlang table 352 based on the corresponding number of users, in step 22.

The same-cell interference is calculated using the equation 2, in step 23, then the reuse efficiency is calculated using the equation 8, in step 24.

The adjacent-cell interference is calculated, in step 25. As a result, the total interference is determined and used to calculate the number of users available.

The number of users is converted to the traffic volume of each pixel using the look-up Erlang table 352, in step 26.

The individual pixels are sorted by propagation loss, in step 27, and then the actual cell coverage is determined by taking pixels corresponding to the traffic volume calculated in step 26 in consideration of both forward and backward interferences, starting from the pixel having the least propagation loss.

The apparatus and method for estimating a cell coverage according to the embodiment of the present invention allows positioning of the base station and its cell design more effectively in the case of installing a base station in a new area or an additional base station with an increase in the traffic in the existing area.

When estimating the coverage of a base station based on no more than the output of the base station to be established and the propagation loss according to the propagation environment or establishing a base station only based on the experience of the operator, there may be an inefficiency such that the cell coverage estimated is overlapped with the actual cell coverage or output of the actual one in a certain area. Contrarily, the present invention allows estimation of a cell coverage more approximating the actual cell coverage by determining a forward link cell coverage based on the traffic and then a forward link cell coverage including both a same-cell interference and an adjacent-cell interference inevitably occurring in the forward link.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

As described above, the present invention provides an apparatus and method for estimating a cell coverage that allows estimation of a cell coverage more approximating the actual cell coverage by estimating a forward link cell coverage based on the traffic and then a forward link cell coverage including a same-cell interference and an adjacent-cell interference inevitably occurring in the forward link.

What is claimed is:

1. An apparatus for estimating a cell coverage, which estimates a cell coverage according to the output of a base station and a propagation loss, the apparatus comprising:
a terrain data processor for dividing an area for calculation of the coverage into pixels of a predetermined size;
a traffic calculator for estimating a traffic volume by the respective pixels;
a forward coverage estimator for calculating path loss information according to the pixel-based traffic volume and a predetermined traffic carrying capacity of the base station and determining a forward link capacity and a forward coverage; and
a backward coverage estimator for calculating a same-cell interference and an adjacent-cell interference using the path loss information between the base stations and determining a backward link capacity and a backward coverage.

2. The apparatus as claimed in claim 1, further comprising:
an operational data database for storing area-based traffic data, the pixel-based traffic volume being calculated using an average traffic volume of the respective areas.

3. The apparatus as claimed in claim 1, wherein the forward coverage estimator determines the number of pixels occupying each area divided by pixels of a predetermined size to estimate the total traffic volume.

4. The apparatus as claimed in claim 1, wherein the backward coverage estimator sums the same-cell interference and the adjacent-cell interference to calculate a backward link interference.

5. The apparatus as claimed in claim 1, wherein the backward coverage estimator converts the traffic volume of the forward coverage to the number of users to calculate a backward link interference in determining the backward coverage based on the forward coverage.

6. The apparatus as claimed in claim 1, further comprising:
a look-up Erlang table for storing a traffic volume corresponding to the number of users,
the backward coverage estimator for calculating a backward link interference to determine the number of users and converts the number of users to the traffic volume using the look-up Erlang table.

7. The apparatus as claimed in claim 6, wherein the backward coverage estimator determines a final coverage by taking pixels of as much as the converted traffic volume among the pixels sorted according to the propagation loss.

8. A method for estimating a cell coverage, which estimates a cell coverage according to the output of a base station and a propagation loss, the method comprising:
(a) dividing an area for calculation of the coverage into pixels of a predetermined size;
(b) calculating a traffic volume by the respective pixels;
(c) calculating path loss information according to the pixel-based traffic volume and a predetermined traffic carrying capacity of the base station to determine a forward link capacity and a forward coverage; and
(d) calculating a same-cell interference and an adjacent-cell interference using the path loss information between the base stations to determine a backward link capacity and a backward coverage.

9. The method as claimed in claim 8, wherein the step (b) comprises calculating the pixel-based traffic volume using an average traffic volume of the respective areas.

10. The method as claimed in claim 8, wherein the step (c) comprises determining the number of pixels occupying the individual area divided into pixels of a predetermined size to calculate the total traffic volume.

11. The method as claimed in claim 8, wherein the step (c) comprises:
initializing a base station transmit power to a predetermined value and selecting an active cell;
determining a traffic volume of the selected active cell;
comparing the calculated traffic volume with a traffic carrying capacity of the base station;
determining the current active cell as the cell coverage when the traffic volume is not greater than the traffic carrying capacity of the base station, and reducing the cell area by the traffic carrying capacity, while excluding the pixels according to the propagation loss, starting from the pixel having the lowest receive sensitivity; and
determining a coverage corresponding to the traffic carrying capacity of the base station as the cell coverage.

12. The method as claimed in claim 11, wherein the step of determining the active cell comprises:
calculating a receiver sensitivity using a path loss value for the individual pixel unit in an area divided into pixel units, the receiver of each pixel belonging to a base station having a highest transmit signal power so that the respective pixels in the area belong to a base station having a highest received power.

13. The method as claimed in claim 12, wherein the step (d) comprises:
determining a reference C/I (carrier-to-interference ratio);
calculating the number of users from the traffic volume in the forward coverage using a look-up Erlang table;
calculating a same-cell interference and a reuse efficiency;
calculating an adjacent-cell interference and determining a total interference and the number of users available from the calculated adjacent-cell interference; and
converting the number of users to a pixel-based traffic volume using the look-up Erlang table, sorting the pixels by propagation loss and determining a cell coverage in consideration of both forward and backward link interferences by taking the pixels of as much as the calculated traffic volume, starting from the pixel having the least propagation loss.

14. The method as claimed in claim 8, wherein the step (d) comprises summing the same-cell interference and the adjacent-cell interference to determine the backward link interference.

15. The method as claimed in claim 8, wherein the step (d) comprises converting the traffic volume of the forward coverage to the number of users to determine the backward link interference based on the forward coverage.
